(19) United States
(12) Patent Application Publication
(10) Pub. No.: US 2017/0016997 A1
(43) Pub. Date: Jan. 19, 2017

(54) RADIATION DETECTOR AND RADIATION IMAGING SYSTEM

(71) Applicant: Konica Minolta, Inc., Tokyo (JP)

(72) Inventors: Hiromichi SHINDOU, Tokyo (JP); Takehiko SHOJI, Tokyo (JP)

(21) Appl. No.: 15/208,183

(22) Filed: Jul. 12, 2016

(30) Foreign Application Priority Data
Jul. 15, 2015 (JP) 2015-141135

(51) Int. Cl. G01T 1/20; G01T 1/202

(52) U.S. Cl. CPC G01T 1/2018; G01T 1/202

(57) ABSTRACT

The present invention is directed to obtain a radiation detector and a radiation imaging system that can perform one-shot energy subtraction method at low cost. The radiation detector of the invention includes a phosphor (Fa), a phosphor (Fb) having a different fluorescence lifetime from the phosphor (Fa), a light receiving element that uses an internal photoelectric effect, and a controller that controls the light receiving element to perform, for one-shot X-ray irradiation, a plurality of times of reading of morphological image information at a time interval.

### BACKGROUND OF THE INVENTION

1. Field of the Invention

The present invention relates to a radiation detector and a radiation imaging system including the radiation detector.

2. Description of the Related Art

Conventionally, radiation images such as X-ray images are widely used for diagnosis of disease conditions in medical settings. An X-ray image is obtained by exposing a subject to an X-ray and visualizing an X-ray having passed through the subject. Energy subtraction method is one of X-ray image acquisition methods that utilize a fact that specific structural parts of a subject, such as organs, bony parts, and blood vessels of a patient, have specific radiation energy characteristics. This is a method for acquiring an intended image on the basis of differential information between two radiation images acquired by using radiation rays with mutually different energy distributions. Specifically, such two radiation images can be obtained by preparing two types of photoreceptors or phosphors having mutually different radiation energy absorption characteristics and irradiating the two types of photoreceptors or phosphors with an X-ray having passed through a subject. Then, in the energy subtraction method, the two radiation images thus obtained are used as sources to be preliminarily subjected to brightness adjustment, as needed, and differences between one of the radiation images and the other one thereof are extracted, thereby giving a morphological image based on an energy component by which an intended portion of the subject is clearly presented.

Energy subtraction method is classified into a one-shot imaging method and a two-shot imaging method according to the number of times of X-ray exposure required to obtain two radiation images that serve as sources. In the one-shot imaging method, an X-ray having passed through a subject is simultaneously applied to two types of photoreceptors or phosphors having mutually different radiation energy absorption characteristics to obtain two radiation images that serve as sources by one-shot X-ray exposure. Such a one-shot energy subtraction method has been studied and developed in various ways.

As an example of radiation detectors used in such a one-shot energy subtraction method, Patent Document 1 discloses a radiation detection apparatus having a structure in which a first scintillator layer and a second scintillator layer that emit light with different wavelengths are stacked on a sensor panel, and the sensor panel is provided with a sensor unit including a plurality of photoelectric conversion units that individually convert respective light beams having mutually different wavelengths into electrical signals. Patent Document 1 above discloses, as a first embodiment, a radiation detection apparatus of an embodiment in which a sensor panel includes a plurality of photoelectric conversion units each separately having a region that detects light from the first scintillator layer and a region that detects light from the second scintillator layer. Additionally, as a second embodiment, there is disclosed a radiation detection apparatus of an embodiment in which a plurality of photoelectric conversion units constituting a sensor panel are divided into two selected from photoelectric conversion units detecting only light from a first scintillator layer, photoelectric conversion units detecting only light from a second scintillator layer, and photoelectric conversion units detecting light from both the first and second scintillator layers by a planar pattern according to the presence or absence of a color filter or a planar pattern according to color filters having mutually different colors.

Additionally, as a radiation detector including a first scintillator that mainly absorbs a low energy component of radiation energy and converts it into visible light and a second scintillator that mainly absorbs a high energy component thereof and converts it into visible light, Patent Document 2 discloses a radiation detection apparatus that includes a first solid state detector composed of a first scintillator and a first photoelectric conversion layer that converts visible light converted by the first scintillator into electrical signals and a second solid state detector composed of a second scintillator and a second photoelectric conversion layer that converts visible light converted by the second scintillator into electrical signals. Patent Document 2 describes that the first scintillator can be composed of a material including an element with an atomic weight of 55 or less as a matrix and the second scintillator can be composed of a material including an element with an atomic weight of 64 or more as a matrix. In addition, Patent Document 2 also describes that the first scintillator tends to absorb, of radiation energy absorption characteristics, a low energy component that exhibits a large absorption difference between bony parts and soft-tissue parts of a subject (patient), whereas the second scintillator tends to absorb, of the radiation energy absorption characteristics, a high energy component that exhibits a small absorption difference between the bony parts and the soft-tissue parts of the subject (patient).

In addition, Patent Document 3 discloses a radiation detection apparatus constituted by stacking a first sensor panel, a layer made of a first scintillator, a non-columnar portion serving as a reflection layer, a layer made of a second scintillator, and a second sensor panel in this order.

Additionally, Patent Document 4 discloses an X-ray image detection apparatus constituted by stacking a layer made of a first scintillator, a sensor panel provided with pixels disposed on both surfaces thereof, and a layer made of a second scintillator in this order.

### CITATION LIST

Patent Document 1: JP-A-2013-127371

Patent Document 2: JP-A-2011-000235

Patent Document 3: JP-A-2012-233780

Patent Document 4: JP-A-2013-002881

### SUMMARY OF THE INVENTION

In acquiring an X-ray image based on the energy subtraction method, the one-shot energy subtraction method is advantageous in that radiation exposure is less than in the two-shot energy subtraction method. However, conventional techniques are problematic in that a light receiving element is required for each of luminescence wavelengths of phosphors constituting a plurality of provided scintillator layers. It is thus necessary to use a radiation detector configured to include a sensor panel having a special structure, to use a radiation detector configured to include a plurality of sensor panels, or to dispose a color filter having a planar pattern consisting of a plurality of colors between a scintillator layer and a sensor panel, as exemplified in Patent Document 1 to 4. This has lead to a problem of cost increase.

On the other hand, the two-shot energy subtraction requires no sensor panel having a special structure, and thus is advantageous in terms of cost. However, there are disadvantages in that image quality tends to be degraded by the appearance of artifacts due to slight motion of a site to be imaged and also radiation exposure is increased.

Accordingly, it is an object of the present invention to obtain a radiation detector and a radiation imaging system that can perform one-shot energy subtraction method at low cost.

The present inventors found out that a one-shot energy subtraction method can be performed by employing two types of phosphors having mutually different fluorescence lifetimes as those required for acquiring two radiation images that serve as sources in performing energy subtraction, without any need for use of a sensor panel having a special structure or use of a plurality of sensor panels, thereby completing the invention.

To achieve at least one of the above-described problems, a first embodiment of the present invention resides in a radiation detector including:

a phosphor (Fa);

a phosphor (Fb) having a longer fluorescence lifetime than the phosphor (Fa);

a light receiving element that uses an internal photoelectric effect; and

a controller that controls the light receiving element to perform, for one-shot X-ray irradiation, reading of morphological image information based on fluorescence emitted from the phosphors (Fa) and (Fb), a plurality of times at a time interval.

In addition, a second embodiment of the present invention resides in a radiation imaging system including the radiation detector and a mechanism that performs arithmetic processing by using information obtained by the plurality of times of the reading.

According to the present invention, a one-shot energy subtraction method can be performed at low cost, whereby the appearance of artifacts and radiation exposure can be reduced as compared to two-shot energy subtraction method.

### BRIEF DESCRIPTION OF THE DRAWINGS

FIG. 1 is an illustrative view depicting a basic principle of the present invention;

FIG. 2 is an illustrative view of FIG. 1 represented by a logarithmic chart;

FIG. 3 is a schematic diagram depicting a basic structure of a radiation detector according to a specific embodiment of the invention;

FIG. 4 is a schematic diagram depicting a radiation detector according to a preferable embodiment of the invention;

FIG. 5 is a schematic diagram depicting a radiation detector according to another embodiment of the invention; and

FIG. 6 is a schematic diagram depicting the structure of an exemplary vapor deposition apparatus usable in the invention.

### DESCRIPTION OF EMBODIMENTS

Hereinafter, the present invention will be described specifically.

In the present specification, the term “light” indicates, among electromagnetic waves, electromagnetic waves in a wavelength range consisting of ultraviolet light, visible light in the center, and infrared light regions, and more specifically, electromagnetic waves having wavelengths ranging from 300 to 800 nm. In addition, the term “phosphor” or “scintillator” indicates a fluorescent material that absorbs energy of incident radiation such as an X-ray and emits the above-mentioned “light”.

In addition, the term “afterglow” indicates a phenomenon in which, when energy of incident radiation such as an X-ray is supplied to a phosphor, the phosphor still emits the “light” even after cessation of the energy supply, or light observed due to such a phenomenon.

Additionally, in the present specification, the term “height” is used as a concept that represents a position in a film thickness direction.

### [Radiation Detector]

A radiation detector according to the present invention comprises a phosphor (Fa); a phosphor (Fb) having a longer fluorescence lifetime than the phosphor (Fa); and a light receiving element that uses an internal photoelectric effect, and performs, for one-shot X-ray exposure, reading of morphological image information based on fluorescence emitted from the phosphors (Fa) and (Fb), a plurality of times at a time interval.

<Light Receiving Element that Uses an Internal Photoelectric Effect>

The radiation detector of the present invention includes a light receiving element that uses an internal photoelectric effect. The “light receiving element that uses an internal photoelectric effect” has a function that can convert fluorescence emitted from the phosphors (Fa) and (Fb) into electrical signals and can externally output the obtained electrical signals as morphological image information.

Herein, the expression “light receiving element that uses an internal photoelectric effect” broadly means a light receiving element that converts light into an electrical charges on the basis of a phenomenon in which, when a semiconductor is irradiated with light, conduction electrons in the semiconductor are increased. This is a concept that excludes light receiving elements that convert light into electrical charges on the basis of a phenomenon in which light irradiation of a material causes electrons to be released from a surface of the material, i.e., light receiving elements based on an external photoelectric effect, such as phototubes and photomultiplier tubes. Such a “light receiving element that uses an internal photoelectric effect” is not particularly limited as long as the element can convert fluorescence emitted from the phosphors into electrical charges by the internal photoelectric effect, accumulate the electrical charges to convert them into electrical signals, and externally read out the electrical signals. Specific examples thereof include TFT image sensors, CCD image sensors, and CMOS image sensors.

In addition, in the following description, the light receiving element that uses an internal photoelectric effect may be simply referred to as “light receiving element”.

### <Phosphor (Fa) and Phosphor (Fb)>

The present invention includes, as phosphors constituting the radiation detector, the phosphor (Fa) and the phosphor (Fb) that has a longer fluorescence lifetime than the phosphor (Fa) (which may be simply referred to as “phosphor (Fb)”). In other words, the radiation detector of the invention includes, as phosphors, the plurality of phosphors having mutually different fluorescence lifetimes.

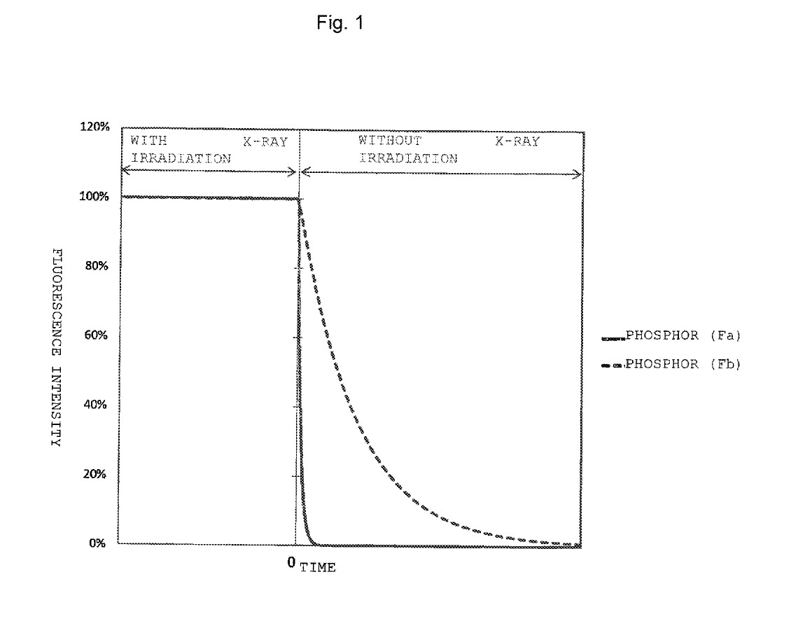

Now, the basic principle of the present invention will be described with reference to FIG. 1.

The phosphors constituting the radiation detector absorb energy of X-ray radiation by X-ray irradiation and emit light, and when radiation irradiation is terminated, the fluorescent luminescence is attenuated over time and finally disappears. When radiation is simultaneously applied to both the phosphor (Fa) and the phosphor (Fb) having a longer fluorescence lifetime than the phosphor (Fa), fluorescence is emitted from both the phosphors (Fa) and (Fb) while the X-ray irradiation is continuing, as depicted in FIG. 1. Then, even after the X-ray irradiation is ceased, the fluorescent luminescence emitted from the phosphors (Fa) and (Fb) does not immediately disappear and continues for some time in form of afterglows while being attenuated over time. However, the phosphor (Fb) has a longer fluorescence lifetime, i.e., a longer afterglow duration than the phosphor (Fa). Thus, the afterglow from the phosphor (Fa) is attenuated earlier and becomes unobservable. Thereafter, the afterglow from the phosphor (Fb) continues for some time although gradually being attenuated, and then becomes unobservable. This means that, depending on the time of X-ray observation, a ratio between a fluorescent luminescence intensity from the phosphor (Fa) and a fluorescent luminescence intensity from the phosphor (Fb) varies.

The reason that the radiation detector of the invention performs, for one-shot X-ray exposure, the reading of morphological image information based on fluorescence emitted from the phosphors (Fa) and (Fb), a plurality of times at a time interval is to allow a plurality of pieces of morphological image information mutually different in a ratio between a luminescence intensity from the phosphor (Fa) and a luminescence intensity from the phosphor (Fb) to be obtained on the basis of the fact described above. Thereby, a morphological image information component based on fluorescence from the phosphor (Fa) and a morphological image information component based on fluorescence from the phosphor (Fb) can be extracted in form of a subtraction image obtained from the plurality of pieces of morphological image information. Since X-ray energy component absorption characteristics are different between the phosphors (Fa) and (Fb), the subtraction image is presented.

In the present invention, a phosphor that can be used as the phosphor (Fa) is not particularly limited as long as it can efficiently convert energy of an X-ray coming from an outside into light, and can be any of conventionally well-known various phosphors that are used as X-ray scintillators. Examples of such phosphors include inorganic crystals such as Gd₂O₂S (hereinafter “GOS”), NaI, CsI, CsBr, CsBa₂I₅, SrI₂, SrBr₂, ZnS, CaI₂, CaBr₂, CaWO₄, BaSO₄, BaFCl, BaF (Br, I), BaAl₂O₄, LaBr₃, CeBr₃, CeF₃, Y₂O₃, Y₂O₂S, (Y, Gd)₂O₂S, and YTaO₄. In the present invention, any of the above-mentioned compounds such as GOS and CsI may be used as it is, as phosphors to be used as the phosphor (Fa) and (Fb). However, from the viewpoint of sufficiently securing luminescence efficiency, it is preferable to use, as the phosphors (Fa) and (Fb), phosphors prepared by using any of the above compounds as a phosphor matrix compound (hereinafter may be simply referred to as “matrix”) and doping any of various kinds of activators in the phosphor matrix compound. Suitable examples of such activators include activating substances such as In, Tl, Li, Na, K, Rb, Eu, Tb, Dy, and Cu, and at least one or more thereof is preferably included.

In the present invention, examples of phosphors that can be particularly suitably used as the phosphor (Fa) include CsI:Tl, CsI:Tl,Na, and GOS:Tb. As compared to the phosphor (Fb), the phosphor (Fa) is considered to generally tend to readily absorb a relatively high energy component in an X-ray.

Basically, a phosphor that can be used as the phosphor (Fb) can also be any of conventionally well-known various types of phosphors used as X-ray scintillators, as with the phosphor (Fa). However, in the invention, a phosphor that can be used as the phosphor (Fb) is required to have a longer fluorescence lifetime than the phosphor (Fa). For example, when a phosphor having a relatively short fluorescence lifetime, such as CsI:Tl or GOS:Tb, is used as the phosphor (Fa), preferable examples of the phosphor (Fb) include CsI:Tl,Na, ZnS:Cu,Cl, Y₂O₃:Tb, and BaAl₂O₄:Eu,Dy. As compared to the phosphor (Fa), the phosphor (Fb) is considered to generally tend to readily absorb a relatively low energy component in an X-ray.

Herein, as one of preferable embodiments of the present invention, there may be mentioned an embodiment in which a matrix constituting the phosphor (Fa) is the same as a matrix constituting (Fb). Examples of the embodiment include the following embodiments (i) to (iii), but not limited thereto:

(i) an embodiment in which the phosphor (Fa) includes a phosphor matrix compound, and the phosphor (Fb) includes the phosphor matrix compound and an activator;

(ii) an embodiment in which the phosphor (Fa) includes a phosphor matrix compound and a first activator, and the phosphor (Fb) includes the phosphor matrix compound and a second activator; and

(iii) an embodiment in which the phosphor (Fa) includes a phosphor matrix compound and a first activator, and the phosphor (Fb) includes the phosphor matrix compound, the first activator, and a second activator.

In the present invention, the phosphors (Fa) and (Fb) preferably satisfy a relationship: τb/τa is 16.5 or more, and more preferably satisfy a relationship: τb/τa is 65 or more, where τa and τb respectively represent periods of time taken for amounts of luminescence from the phosphors (Fa) and (Fb) to reach 1/100 of amounts of luminescence therefrom at a time of cessation of X-ray irradiation from the time of the cessation of the X-ray irradiation.

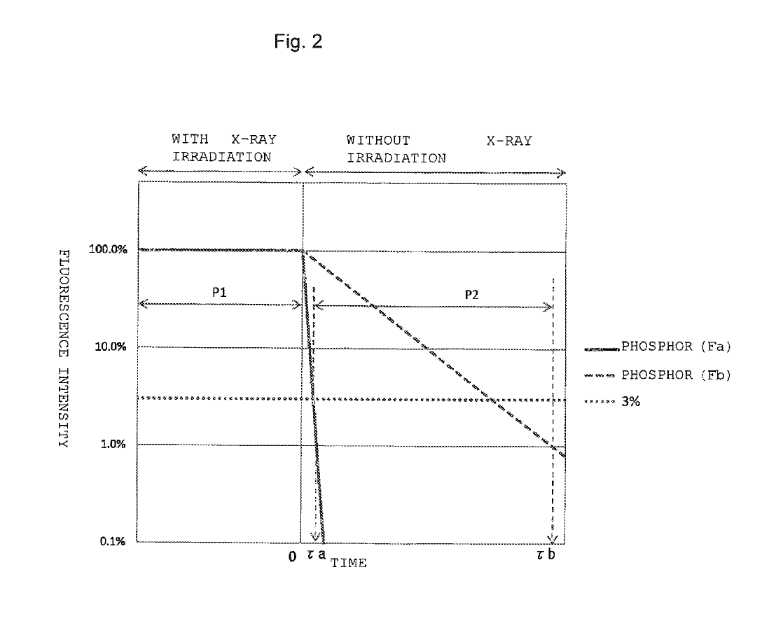

The reason for the above definition of the τa and τb will be described with reference to FIGS. 1 and 2.

As described above, when X-ray irradiation terminates in a system in which both the phosphors (Fa) and (Fb) are irradiated with an X-ray, the afterglow from the phosphor (Fa) and the afterglow from the phosphor (Fb) are both attenuated over time and finally diminished to a hardly detectable level, as depicted in FIG. 1. Herein, when measuring the afterglows from the phosphors (Fa) and (Fb) by the “light receiving element”, influence of noise on the light receiving element needs to be also considered. Given that, in many cases, the “light receiving element” tends to have a lower detective quantum efficiency (DQE) as input radiation dose is smaller, when measuring afterglows from the phosphors (Fa) and (Fb), the afterglows to be measured are desired to have large intensity to an extent that can secure a certain level or more of DQE (e.g., 10%), from the viewpoint of securing a certain level of X-ray image quality. In the case of measuring fluorescent luminescence from each of the phosphors (Fa) and (Fb) by using the “light receiving element”, it is presumed that a frequently used light receiving element has a DQE of around 50% in fluorescent luminescence intensity at a time of cessation of X-ray irradiation. In the use of such a light receiving element, an input radiation dose required to secure a DQE of 10% or more can be estimated to be about 1/100 of a fluorescent luminescence intensity of the phosphor at the time of cessation of X-ray irradiation. Based on the estimation, the present invention has set a reference amount of luminescence when measuring fluorescent luminescence intensities from the phosphors (Fa) and (Fb) by the “light receiving element” to 1/100 of the amount of luminescence at a time of cessation of X-ray irradiation, and also has defined the τa and τb according to the reference.

As examples of embodiments for obtaining morphological image information by using the radiation detector of the invention, there may be mentioned an embodiment for obtaining the information as a still image and an embodiment for obtaining the information in form of a moving image or a quasi-moving image.

In the embodiment for obtaining morphological image information in form of a moving image or a quasi-moving image, fluorescence lifetimes required for the phosphors (Fa) and (Fb) are dependent on frame rates in obtaining the moving image and the quasi-moving image. For example, in the case of obtaining a moving image of morphological image information, an example of a typical frame rate is 30 fps (frames per second). In this case, an interval between frames is about 33 milliseconds (≈1000/30). On the other hand, in the case of obtaining a quasi-moving image of morphological image information, an example of a typical frame rate is 7.5 fps, and, in this case, an interval between frames is about 130 milliseconds (≈1000/7.5). Examples of imaging patterns in the case of obtaining a subtraction image from a moving image or a quasi-moving image by using the radiation detector of the invention include a pattern in which morphological image information obtained by performing X-ray irradiation is recorded in a first frame, and then, morphological image information obtained by ceasing the X-ray irradiation is recorded in a subsequent second frame, and according to needs, recording of morphological image information obtained by X-ray irradiation and recording of morphological image information obtained by cessation of the X-ray irradiation are alternately repeated in subsequent frames. Given that it is very likely that a phosphor whose Ta is around 2 to 3 milliseconds is frequently used as the phosphor (Fa), it is advantageous that the τb/τa is 16.5 or more, because recording of a moving image of morphological image information at the frame rate of 30 fps can be performed with sufficiently high image quality. Furthermore, when the τb/τa is 65 or more, recording of a quasi-moving image of morphological image information at the frame rate of 7.5 fps can also be suitably performed.

On the other hand, in the case of a still image of morphological image information by using the radiation detector of the invention, the frame rate does not have to be considered. However, when the τb/τa is in the above range, it is advantageous, because the difference between morphological image information obtained by performing X-ray irradiation and morphological image information obtained by subsequently ceasing the X-ray irradiation becomes sufficiently clear, and therefore an obtained subtraction image can have sufficiently high image quality.

In addition, the phosphors (Fa) and (Fb) in the radiation detector of the invention satisfy a relationship: μa/μb or μb/μa is preferably 1.2 or more, and more preferably, 2.8 or more, where μa and μb respectively represent mass attenuation coefficients thereof at a time of X-ray irradiation at a tube voltage of 80 keV. Each of the mass attenuation coefficients is an index that indicates the degree of attenuation when an X-ray passes through each of the phosphors, i.e., the degree of X-ray energy absorption in each of the phosphors. The index can particularly be an important factor when the radiation detector of the invention is configured according to an embodiment in which the phosphors (Fa) and (Fb) are stacked vertically on top of each other with respect to an X-ray incidence direction. In the radiation detector of such an embodiment, one of the phosphors (Fa) and (Fb) that has less X-ray energy absorption is preferably located closer to a radiation incidence side so that the other one of the phosphors (Fa) and (Fb) located farther from the radiation incidence side can obtain sufficiently much X-ray energy. To do so, it is more advantageous that the degrees of X-ray energy absorption in the phosphors are significantly different.

### Presence Form of Phosphors (Fa) and (Fb) and Scintillator Layer

In the radiation detector of the invention, the presence form of the phosphors (Fa) and (Fb) is not particularly limited as long as fluorescence patterns from the phosphors (Fa) and (Fb) are captured as X-ray images. However, preferably, the phosphors (Fa) and (Fb) are disposed parallel to each other or stacked vertically on top of each other, with respect to a radiation incidence direction, and particularly preferably, stacked vertically on top of each other with respect thereto, in terms of enabling the radiation detector to be manufactured more simply and easily and improving energy discrimination accuracy. When the phosphors (Fa) and (Fb) are stacked vertically on top of each other with respect to a radiation incidence direction, fluorescence from the phosphor (Fa) and fluorescence from the phosphor (Fb) can be obtained in the same planar position. This is advantageous in forming a subtraction image.

In the case where the phosphors (Fa) and (Fb) are stacked vertically with respect to a radiation incidence direction, when μa≦μb, the phosphor (Fa) is preferably located closer to the radiation incidence side, whereas when μa>μb, the phosphor (Fb) is preferably located closer to the radiation incidence side, where μa and μb respectively represent mass attenuation coefficients of the phosphors (Fa) and (Fb) at a time of X-ray irradiation at a tube voltage of 80 keV. Such a structure allows the phosphor located farther as viewed from the radiation incidence side to receive much more X-ray energy, and therefore is advantageous in forming a subtraction image.

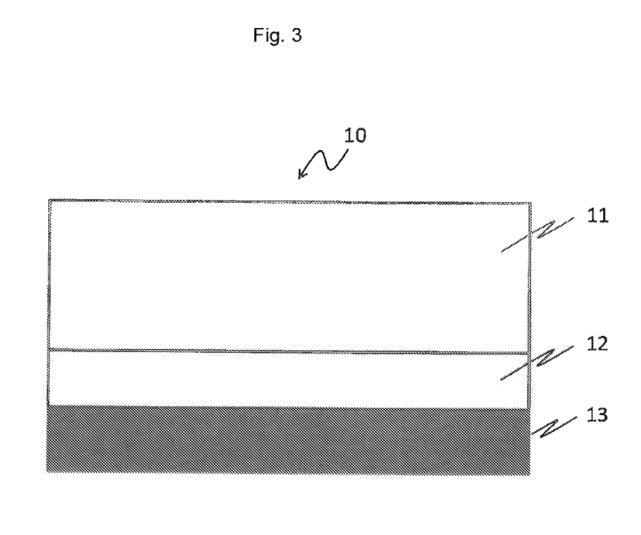

A specific presence form of the phosphors (Fa) and (Fb) in the invention will be further described with reference to FIGS. 3 to 5.

In a general form thereof in the invention, the phosphors (Fa) and (Fb) constitute a scintillator layer and are located on a surface of the “light receiving element”. In other words, in a typical embodiment, a radiation detector 10 of the invention includes a light receiving element 11 that uses the internal photoelectric effect (hereinafter “light receiving element 11”) and a scintillator layer 12 contacted with the light receiving element 11, as exemplified in FIG. 3. The scintillator layer 12 includes the phosphors (Fa) and (Fb) therein. Additionally, in many embodiments, the radiation detector 10 of the invention may include a support 13 on a side opposite to the light receiving element 11 as viewed from the scintillator layer 12, in addition to the light receiving element 11 and the scintillator layer 12.

Herein, the presence form of the phosphors (Fa) and (Fb) in the scintillator layer 12 is not particularly limited, and examples of the presence form thereof include the following forms:

(C1) a scintillator layer that includes particles (Pa) made of the phosphor (Fa), particles (Pb) made of the phosphor (Fb), and a binder resin, in which the particles (Pa) and (Pb) are dispersed in the binder resin;

(C2) a scintillator layer that includes a plurality of dots (Da) including the phosphor (Fa) and a plurality of dots (Db) including the phosphor (Fb), respectively, in which the dots (Da) and the dots (Db) are disposed independently of and alternately to each other, and parallel to a radiation incidence direction; and

(C3) a scintillator layer that includes a first scintillator layer and a second scintillator layer positioned between the first scintillator layer and the “light receiving element”, in which the first scintillator layer includes one of the phosphors (Fa) and (Fb), and the second scintillator layer includes the other one thereof.

### Scintillator Layer (C1)

The binder resin constituting the scintillator layer (C1) is not particularly limited as long as it does not destroy the particles (Pa) made of the phosphor (Fa) and the particles (Pb) made of the phosphor (Fb) and can transmit and deliver fluorescence emitted from the particles (Pa) made of the phosphor (Fa) and the particles (Pb) made of the phosphor (Fb) to the “light receiving element”. Conventionally well-known resins frequently used in the field of X-ray scintillators can be used as the binder resin. Additionally, adjustment can be made, as appropriate, to a mixing ratio between the particles (Pa) made of the phosphor (Fa) and the particles (Pb) made of the phosphor (Fb). An average particle size of the particles (Pa) made of the phosphor (Fa) and the particles (Pb) made of the phosphor (Fb) is not particularly considered as long as it is a commonly employed size. In many cases, particles having an average particle size of from 1 to 20 μm can be suitably used.

### Scintillator Layer (C2)

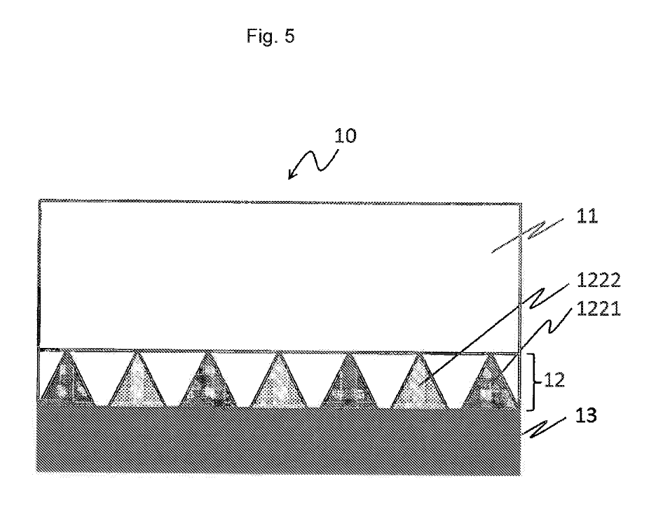

The above scintillator layer (C2) is a typical example of the form in which “the phosphors (Fa) and (Fb) are disposed parallel to each other with respect to a radiation incidence direction”. An example of the radiation detector including the scintillator layer (C2) is a radiation detector having a structure depicted in FIG. 5. As depicted in FIG. 5, in the radiation detector 10 of the present embodiment, the scintillator layer 12 includes a dot (Da) including the phosphor (Fa) (hereinafter “dot (Da)”) 1221 and a dot (Db) including the phosphor (Fb) (hereinafter “dot (Db)”) 1222 in plurality, respectively, in which the dots (Da) 1221 and the dots (Db) 1222 are disposed independently of and alternately to each other, and parallel to a radiation incidence direction. Herein, the planar pattern including the dots (Da) 1221 and the dots (Db) 1222 is not particularly limited, and, for example, can be a pattern in which the dots (Da) 1221 and the dots (Db) 1222 are disposed in an alternately staggered manner.

The dots (Da) 1221 may include an appropriate binder resin other than the phosphor (Fa), and, for example, may have a structure in which particles made of the phosphor (Fa) are dispersed in the binder resin. Similarly, the dots (Db) 1222 may also include an appropriate binder resin other than the phosphor (Fb), and, for example, may have a structure in which particles made of the phosphor (Fb) are dispersed in the binder resin. The binder resin that can constitute the dots (Da) 1221 and the dots (Db) 1222 is not particularly limited as long as it does not destroy the particles made of the phosphor (Fa) and the particles made of the phosphor (Fb) and can transmit and deliver fluorescence emitted from the particles made of the phosphors (Fa) and the particles made of the phosphor (Fb) to the “light receiving element”. The binder resin can be any of conventionally well-known resins frequently used in the field of X-ray scintillators.

In addition, sizes and the like of the individual dots (Da) 1221 and (Db) 1222 can also be determined as appropriate. Additionally, an average particle size of the particles made of the phosphor (Fa) and the particles made of the phosphor (Fb) is not particularly considered as long as it is a commonly employed size. In many cases, particles having an average particle size of from 1 to 20 μm can be suitably used.

### Scintillator Layer (C3)

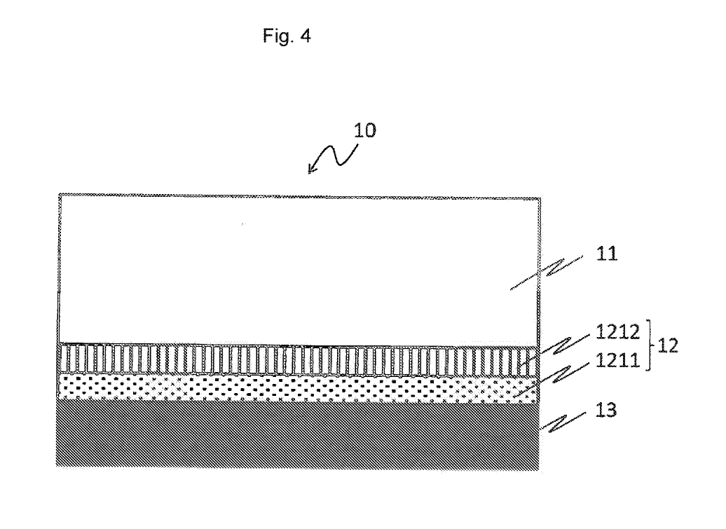

The scintillator layer (C3) is a typical example of the form in which “the phosphors (Fa) and (Fb) are stacked vertically on top of each other with respect to a radiation incidence direction”. An example of the radiation detector including the scintillator layer (C3) is a radiation detector having a structure depicted in FIG. 4. As depicted in FIG. 4, the radiation detector 10 of the present embodiment has a stacked structure including a first scintillator layer 1211 and a second scintillator layer 1212 disposed between the first scintillator layer 1211 and the light receiving element 11. The first scintillator layer 1211 includes one of the phosphors (Fa) and (Fb). Then, the second scintillator layer 1212 includes one of the phosphors (Fa) and (Fb) that is not used in the first scintillator layer 1211. When the radiation detector of the invention includes the scintillator layer (C3), it is convenient in manufacturing the radiation detector, and also advantageous in forming a subtraction image because fluorescence from the phosphor (Fa) and fluorescence from the phosphor (Fb) can be obtained in the same planar position.

Herein, the scintillator layer including one of the phosphors (Fa) and (Fb) that has a smaller mass attenuation coefficient at a time of X-ray irradiation at a tube voltage of 80 keV is preferably located closer to a radiation incidence side. For example, in a case where an X-ray enters from a lower side in FIG. 4 (i.e., a side where an optional support 13 that will be described later is located), preferably, the first scintillator layer 1211 includes the one of the phosphors (Fa) and (Fb) that has a smaller mass attenuation coefficient, and the second scintillator layer 1212 includes the one of the phosphors (Fa) and (Fb) that has a larger mass attenuation coefficient.

The phosphor constituting the first scintillator layer 1211 and the phosphor constituting the second scintillator layer 1212 may be both present in form of columnar crystals or particles.

The first and second scintillator layers 1211 and 1212 may both include an appropriate binder resin when the constituent phosphor (i.e., the phosphor (Fa) or (Fb)) is in form of particles. For example, the first and second scintillator layers 1211 and 1212 may have a structure in which particles made of the constituent phosphor are dispersed in the binder resin. Herein, the binder resin that can constitute the first and second scintillator layers 1211 and 1212 is not particularly limited as long as it does not destroy the particles made of the phosphor (Fa) and the particles made of the phosphor (Fb) and can transmit and deliver fluorescence emitted from the particles made of the phosphor (Fa) and the particles made of the phosphor (Fb) to the “light receiving element”. The binder resin can be any of conventionally well-known resins frequently used in the field of X-ray scintillators. A filling rate of the particles of each constituent phosphor in the first and second scintillator layers 1211 and 1212 is not particularly limited and is preferably from 30 to 85%. An average particle size of the particles made of the phosphor (Fa) and the particles made of the phosphor (Fb) is not particularly considered as long as it is a commonly employed size. In many cases, particles having an average particle size of from 1 to 20 μm can be suitably used.

On the other hand, when the phosphors constituting the first and second scintillator layers 1211 and 1212 are present in form of columnar crystals, the columnar crystals may include an underlayer. Additionally, in the columnar crystals, an activator that can be doped may have a concentration gradient in a height direction thereof unless there is any hindrance to the obtaining of a subtraction image.

In addition, the film thicknesses of the first and second scintillator layers 1211 and 1212 can be set as appropriate according to desired performance, and, for each of the first and second scintillator layers 1211 and 1212, the film thickness is preferably from 50 to 800 μm.

In the scintillator layer (C3), both of the phosphor constituting the first scintillator layer 1211 and the phosphor constituting the second scintillator layer 1212 may be present in form of columnar crystals or in form of particles. Alternatively, the scintillator layer (C3) may have a structure in which one of the phosphors constituting the first and second scintillator layers 1211 and 1212 is present in form of columnar crystals, and the other one thereof is present in form of particles. For example, in an embodiment, the phosphor constituting the first scintillator layer 1211 may be in form of particles and the phosphor constituting the second scintillator layer 1212 may be in form of columnar crystals.

In addition, the scintillator layer (C3) may include two or more first scintillator layers 1211. The scintillator layer (C3) may include two or more second scintillator layers 1212, too.

### Means for Performing a Plurality of Times of Reading of Morphological Image Information at a Time Interval

In the radiation detector of the invention, for one-shot X-ray exposure, reading of morphological image information obtained by the light receiving element on the basis of fluorescence emitted from the phosphors (Fa) and (Fb) is performed a plurality of times at a time interval.

In the radiation detector of the invention, specific means for performing such a reading of morphological image information are not particularly limited. However, in order to perform such a reading of morphological image information in the radiation detector of the invention, generally, there are generally performed a series of steps that include:

(SR-1) a step of instructing the “light receiving element” to start accumulation of first morphological image information;

(SR-2) a step of instructing the light receiving element to terminate the accumulation of the first morphological image information after passage of a predetermined time from the step (SR-1);

(SR-3) a step of reading the first morphological image information accumulated in the light receiving element from the light receiving element after the step (S-2);

(SR-4) a step of waiting until a predetermined time passes from the instruction of the step (SR-1) after completion of the step (SR-3);

(SR-5) a step of instructing the light receiving element to start accumulation of second morphological image information at a time of completion of the step (SR-4);

(SR-6) a step of instructing the light receiving element to terminate the accumulation of the second morphological image information after passage of a predetermined time from the step (SR-5); and

(SR-7) a step of reading the second morphological image information accumulated in the light receiving element from the light receiving element after the step (SR-6). In the case of obtaining morphological image information in form of a moving image or a quasi-moving image, there is performed as needed:

(SR-8) a step of waiting until a predetermined time passes from the instruction of the step (SR-5) after completion of the step (SR-7), and the steps (SR-1) to (SR-8) are repeated again.

Timing for performing these steps will be described with reference to FIG. 2. FIG. 2 depicts two periods P1 and P2. P1 represents a period during which X-ray radiation is applied to the phosphors (Fa) and (Fb) constituting the radiation detector of the invention. The period P1 starts at a time of start of the X-ray irradiation and ends at a time of cessation thereof. In FIG. 2, in terms of time, the time of cessation of the X-ray irradiation is defined as a time point 0. On the other hand, the period P2 starts when luminescence intensity from the phosphor (Fa) is sufficiently reduced after the cessation of the X-ray irradiation (a time point at that time is represented by τa), and after that, additionally, when luminescence intensity from the phosphor (Fb) is reduced to a substantially unobservable level (a time point at that time is represented by τb), the period P 2 ends. In addition, in FIG. 2, X-ray irradiation of the phosphors (Fa) and (Fb) is not performed in a time period including the time points τa and τb after cessation of the X-ray irradiation.

Additionally, in the present specification, in terms of X-ray irradiation, the expression “terminate” may be used instead of the expression “cease”. Both mean a transition from a state where X-ray irradiation is being performed to a state where the X-ray irradiation is not being performed.

In order to allow acquisition of a plurality of pieces of morphological image information different in a ratio between luminescence intensity from the phosphor (Fa) and luminescence intensity from the phosphor (Fb), at least the second morphological image information needs to be acquired after terminating the X-ray irradiation. To do so, it is necessary to perform the steps (SR-5) to (SR-7) after termination of the X-ray irradiation. On the other hand, although acquisition of the first morphological image information can be performed before acquiring the second morphological image information, the first morphological image information is desirably acquired before the termination of the X-ray irradiation so that the difference in the ratio between the luminescence intensity from the phosphor (Fa) and the luminescence intensity from the phosphor (Fb) becomes significantly large between the first morphological image information and the second morphological image information. To do that, at least the step (SR-1), and more preferably, the steps (SR-1) to (SR-2) are desirably performed before the termination of the X-ray irradiation, i.e., during the period P1 in FIG. 2. Given these points, in the radiation detector of the invention, preferably, accumulation of the first morphological image information in the light receiving element is started during X-ray irradiation, and accumulation of the second morphological image information therein is started after termination of the X-ray irradiation and after termination of the accumulation and reading of the first morphological image information.

In addition, when the X-ray irradiation terminates before completion of the step (SR-3) and an afterglow from the phosphor (Fb) is reduced to a sufficiently ignorable level at a time of the completion of the step (SR-3), the step (SR-4) may be omitted. In the case where the step (SR-4) is omitted, the step (SR-5) is performed immediately after the completion of the step (SR-3). In other words, in the case where the step (SR-4) is omitted, the step (SR-5) is replaced by:

(SR-5′) a step of instructing the light receiving element to start accumulation of the second morphological image information at the time of completion of the step (SR-3).

Next, further consideration will be given to a period for starting acquisition of the second morphological image information. In the case of starting acquisition of first morphological image information during X-ray irradiation, it is preferable to make the difference between the first morphological image information and the second morphological image information as large as possible in order to ensure acquisition of a subtraction image with sufficiently high quality. To do that, it is advantageous to start the accumulation of the second morphological image information after a certain length of time passes from the termination of the X-ray irradiation rather than immediately after the termination of the X-ray irradiation. Meanwhile, considering that accumulation of morphological image information takes some time, it is enough as long as the influence of an afterglow from the phosphor (Fa) is ignorable when seen through the whole time of the accumulation of the second morphological image information. Thus, it is considered not indispensable that the afterglow from the phosphor (Fa) should be at an unobservable level at the time of start of the accumulation of the second morphological image information. In other words, it is considered unnecessary to wait to start the accumulation of the second morphological image information for a time until the amount of luminescence from the phosphor (Fa) reaches 1/100 of an amount of luminescence thereof at a time of cessation of the X-ray irradiation from the time of the cessation of the X-ray irradiation. Given the point, preferably, the radiation detector of the invention performs accumulation of second morphological image information after passage of a time equal to or more than a time taken for an amount of luminescence from the phosphor (Fa) to reach 3/100 of an amount of luminescence therefrom at a time of cessation of X-ray irradiation from the time of the cessation of the X-ray irradiation. In other words, in a preferable embodiment of the invention, the step (SR-5) is performed after passage of a time equal to or more than a time taken for an amount of fluorescence from the phosphor (Fa) to reach 3/100 of an amount of fluorescence therefrom at a time of cessation of X-ray irradiation from the time of the cessation of the X-ray irradiation.

On the other hand, from the viewpoint of securing a certain level of X-ray image quality, it is preferable to complete the accumulation of second morphological image information before passage of a time taken for the amount of luminescence from the phosphor (Fb) to reach 1/100 of the amount of luminescence therefrom at a time of cessation of X-ray irradiation from the time of the cessation of the X-ray irradiation. To do so, the step (SR-6) is preferably performed before the passage of the time taken for the amount of luminescence from the phosphor (Fb) to reach 1/100 of the amount of luminescence therefrom at the time of the cessation of the X-ray irradiation from the time of the cessation of the X-ray irradiation.

With these above in mind, the accumulation of second morphological image information is particularly preferably performed within the period P2 depicted in FIG. 2.

The instructions to the light receiving element in such a series of steps are typically performed through a controller that controls the light receiving element. Accordingly, in many cases, the radiation detector of the invention includes a controller that controls the light receiving element (hereinafter referred to as “controller that controls the light receiving element” or “controller”). The “controller that controls the light receiving element” controls the light receiving element on the basis of an instruction defined by a program encoded to cause the light receiving element to perform the series of steps (hereinafter, the program will be referred to as “program” unless otherwise specified). In addition, the radiation detector of the invention includes an interface for outputting each piece of morphological image information read by the steps (SR-3) and (SR-7) to the outside of the radiation detector. In addition, the radiation detector of the invention may include interfaces for inputting instructions and/or information from various apparatuses outside the radiation detector that constitute a radiation imaging system, such as an X-ray irradiation apparatus and a console.

Additionally, the radiation detector of the invention can further include, as needed, a battery and a clock for driving the light receiving element and the “controller that controls the light receiving element”, an appropriate program recording medium accommodating a program that controls the “controller that controls the light receiving element” (i.e., the “program”) (hereinafter “program storage medium”), and a buffer memory or the like for temporarily storing each piece of morphological image information read by the steps (SR-3) and (SR-7).

Herein, the “clock” is a device that is to be exactly referred to as clock generator. Examples thereof include various kinds of oscillators such as crystal oscillators and ceramic oscillators and oscillator modules including the oscillators.

In addition, examples of the recording medium used to store the “program” include computer-readable non-transitory recording media such as ROMs (read-only memories), magnetic discs, and optical discs. Recording the “program” in such a recording medium gives the “program storage medium”. Additionally, the “ROM” referred to in the present specification encompasses rewritable ROMs such as an EEPROM (electrically erasable programmable ROM).

In the present invention, the “controller” may include a known hardware structure as long as it can control the light receiving element on the basis of an instruction defined by the “program”. Typically, the controller includes a central processing unit (CPU), a memory, and an input/output unit for communicating with the light receiving element (hereinafter “input/output unit”). Then, when the “controller” executes the “program”, the “program” is first loaded in the memory. Then, the CPU performs instruction decoding and arithmetic processing on the basis of the “program” loaded in the memory to control the light receiving element via the input/output unit.

Herein, the CPU may be a discrete component by itself, independent from other components such as the memory or may be an integrated circuit included in a microprocessor. In a case where the CPU is an integrated circuit included in a microprocessor, the microprocessor may include a memory. The microprocessor may incorporate the “clock”. The microprocessor may include a ROM storing the “program” (hereinafter “program storage ROM”).

Additionally, in the present invention, the “controller” may be in form of a microcontroller that includes the CPU, the memory, the “input/output unit”, the “clock”, and the “program storage ROM”.

In addition, when the CPU is included in a microprocessor or a microcontroller, the CPU may be referred to as “CPU core” to discriminate from a memory, the “clock”, the “program storage ROM”, and other integrated circuits that may be incorporated in the microprocessor or the microcontroller. The expression “CPU core” is also used to discriminate between two or more CPUs that may be included in the microprocessor or the microcontroller.

The “controller” may be provided separately from the light receiving element or in a form integrated with the light receiving element as long as it can control the light receiving element.

In addition, in the case where the radiation detector of the invention includes interfaces for inputting instructions and/or information from various apparatuses outside the radiation detector that constitute a radiation imaging system, such as an X-ray irradiation apparatus and a console, the radiation detector of the invention is connected to the X-ray irradiation apparatus and the console via the interfaces, so that the control of the light receiving element by the “controller” in the radiation detector thereof can be performed in conjunction with the X-ray irradiation apparatus. Herein, the X-ray irradiation apparatus includes an X-ray source and can start or terminate X-ray irradiation by operating or stopping the X-ray source. Additionally, in a case where the X-ray irradiation apparatus includes a shutter for shielding an X-ray from the X-ray source, start and termination of X-ray irradiation may be performed by opening and closing the shutter.

As described above, in the case where the control of the light receiving element by the “controller” is performed in conjunction with the X-ray irradiation apparatus, the series of steps further include, specifically, the following steps (SR-0) and (SR-S):

(SR-0) a step of starting X-ray irradiation of the “light receiving element” prior to the step (SR-1); and

(SR-S) a step of ceasing the X-ray irradiation of the “light receiving element” after the step (SR-1) and, in a case where the (SR-4) is performed, before the step (SR-4) or, in a case where the (SR-4) is not performed, before completion of the step (SR-3).

The steps (SR-0) and (SR-S) are performed by the X-ray irradiation apparatus and can be done by respectively opening and closing the shutter installed in the X-ray irradiation apparatus, or by operating or stopping the X-ray source. The step (SR-S) is preferably performed after the step (SR-2).

In addition, the section of the above-mentioned “radiation imaging system” includes the description of “radiation imaging system” and “X-ray imaging apparatus”. However, the X-ray irradiation apparatus is used with a concept in which the apparatus includes neither arithmetic processing unit nor monitor, and, in this respect, is discriminated from the “radiation imaging system” and the like. Additionally, the step (SR-0) can alternatively be performed after the step (SR-1).

In addition, the radiation detector of the invention may receive any change made by an external computer in setting data for specifying the program that controls the “controller that controls the light receiving element”. In this case, the radiation detector of the invention may include a recording region for storing setting data to which such a change has been applied, in the appropriate program recording medium, or may include a second recording medium for storing the setting data to which such a change has been applied, in addition to the appropriate program recording medium.

In addition, in a case where morphological image information read from the light receiving element is an analog signal, the radiation detector of the invention can further include an A/D converter and/or an amplifier for signal amplification.

### Other Members

### Support and Reflection Layer

The radiation detector 10 of the invention may include a support 13, as depicted in FIGS. 3 to 5.

Herein, the support 13 by itself is not necessarily an essential member in the radiation detector 10. However, in manufacturing the radiation detector 10 of the invention, a method may be employed in which after forming the scintillator layer 12 on the support 13, the scintillator layer 12 together with the support 13 is mounted onto the light receiving element 11. In this case, the structure of the scintillator layer 12 needs to be maintained by the support 13 for a while until it is mounted onto the light receiving element 11. Accordingly, in many cases, the radiation detector 10 of the invention includes the support 13.

Examples of a material constituting the support 13 include polyolefin-based resins such as polypropylene and polyethylene, polyamide, polyimide, polyvinyl chloride, polystyrene-based resins, polyacrylic resins, polycarbonate-based resins, and polyester resins. Among them, polyester resins such as polyethylene terephthalate, polybutylene terephthalate, and polyethylene-2,6-naphthalate and polyimide resins are preferably used in terms of durability, heat resistance, chemical stability, and the like.

The support 13 has a thickness preferably ranging from 30 to 300 μm in terms of handling and X-ray transmission.

In addition, the radiation detector 10 according to the invention preferably further includes a reflection layer. The reflection layer is a layer that reflects a light component of fluorescence generated in the scintillator layer 12 that is emitted to the side opposite to the light receiving element 11, and guides the light component to the light receiving element 11.

Herein, in an embodiment of the invention, the support 13 itself may be a member that can also serve as the reflection layer. In this case, a material usable as the support 13 may be one prepared by adding a light reflecting substance such as titanium dioxide or calcium carbonate or air bubbles in any of the above-mentioned resins. The support 13 in such an embodiment can be provided by a usual method.

Additionally, in another embodiment of the invention, the reflection layer may be a separate layer from the support 13. In this case, such a reflection layer can be disposed on the support 13, i.e., between the support 13 and the scintillator layer 12. In this embodiment, the reflection layer may be made of a light reflecting substance such as titanium dioxide or calcium carbonate or made of a metal vapor-deposited film made of Al, Ag, Cr, Cu, Ni, Ti, Mg, Rh, Pt, Au, or the like. Such a reflection layer may be provided by directly disposing a light reflecting substance on the support 13, provided by preparing a coating solution containing a light reflecting substance and then applying and drying the coating solution on the support 13, or provided by vapor-depositing a metal such as Al, Ag, Cr, Cu, Ni, Ti, Mg, Rh, Pt, or Au.

Such a reflection layer can be formed to have the same film thickness as that of a reflection layer constituting an ordinary radiation detector, and may be formed as a single layer or two or more layers.

Additionally, the support 13 may include a light shielding layer and/or a light absorbing pigment layer for reflectance adjustment. As for materials and structures constituting the light shielding layer and/or the light absorbing pigment layer and methods for forming these layers, those conventionally well-known that are generally used in the field of X-ray scintillators can be employed as appropriate.

### Humidity-Resistant Protective Film

The radiation detector of the invention preferably further include, as needed, a humidity-resistant protective film so as to cover an outer periphery thereof in such a case that the phosphor (Fa) and/or the phosphor (Fb) are/is deliquescent. The humidity-resistant protective film has a role of preventing the entire panel from humidity to suppress deterioration of the phosphors (Fa) and (Fb).

A material used for such a humidity-resistant protective film may be a conventionally well-known material, and, for example, may be polyparaxylylene or the like. Additionally, a method for forming the film can be a usual method. For example, in the case of forming a humidity-resistant protective film made of polyparaxylylene, a vapor deposition method can be used.

### Method for Manufacturing Radiation Detector

The method for manufacturing the radiation detector according to the invention is not particularly limited as long as the object of the invention is not impaired, and, basically, the method therefor can be the same as a method for manufacturing a conventionally well-known radiation detector, except for using both the phosphors (Fa) and (Fb) as phosphors.

In the radiation detector according to a general embodiment of the invention, the phosphors (Fa) and (Fb) constitute the scintillator layer and are disposed on the surface of the “light receiving element”. Accordingly, by taking an example of the radiation detector of such an embodiment, a description will be given of an exemplary method for manufacturing the radiation detector according to the invention with reference to FIG. 3.

First, a reflection layer or the like is formed, as needed, on a substrate constituting the support 13 by a conventionally well-known method. Herein, the reflection layer can be formed by any of the methods described in the section of “Support and Reflection Layer” in the section of “Other Members”.

Next, the scintillator layer 12 including the phosphors (Fa) and (Fb) is formed on the substrate constituting the support 13 or on a stacked body obtained by forming the reflection layer or the like on the substrate. This step provides a scintillator panel including the support 13 and the scintillator layer 12 that serves as a component of the radiation detector of the invention. In addition, specific procedures for performing the step will be described later.

Next, the scintillator panel is combined with the light receiving element 11. At this time, the light receiving element 11 is mounted to the scintillator panel in such a manner that a surface of the scintillator layer 12 opposite to a surface thereof where the substrate is located faces a light receiving surface of the light receiving element 11. At this stage, the “means for performing a plurality of times of reading of morphological image information at a time interval” may have been mounted to the light receiving element 11.

In the case of forming the radiation detector not including the support 13, a step of separating the substrate constituting the support 13 from the scintillator layer 12 is performed after mounting the light receiving element 11.

After that, as needed, a humidity-resistant protective layer is formed according to a conventionally well-known method so as to completely surround the scintillator layer 12 and, when applicable, the support 13. The humidity-resistant protective layer can be formed by the method described in the section of “Humidity-Resistant Protective Film” in the section of “Other Members”.

In a case where the “means for performing a plurality of times of reading of morphological image information at a time interval” is not provided on the light receiving element 11 upon mounting of the light receiving element 11, mounting of the “means for performing a plurality of times of reading of morphological image information at a time interval” on the light receiving element 11 may be performed immediately before formation of the humidity-resistant protective film or thereafter.

Through the above-described steps, the radiation detector 10 of the invention of the present application can be obtained.

In addition, in the case of forming the radiation detector not including the support 13, the scintillator layer 12 may be directly formed on the light receiving element 11 instead of mounting the light receiving element 11 after formation of the scintillator panel as long as the light receiving element 11 is durable against conditions for forming the scintillator layer 12.

Herein, in the method for manufacturing the radiation detector of the invention, the method for forming the scintillator layer 12 is not particularly limited, and any of conventionally well-known methods can be applied. Hereinafter, for illustration, there will be described methods for forming the above scintillator layers (C1) to (C3) exemplified as the scintillator layer 12 according to the typical embodiment of the invention.

### Method for Manufacturing Scintillator Layer (C1)

In the case of forming the radiation detector 10 including the scintillator layer (C1) as the scintillator layer 12, the scintillator layer (C1) can be formed by a conventionally well-known method. For example, the formation of the scintillator layer (C1) can be performed by coating an appropriate substrate with a phosphor coating liquid including the particles (Pa) made of the phosphor (Fa), the particles (Pb) made of the phosphor (Fb), and a binder resin and then drying the liquid.

For example, the scintillator layer (C1) can be formed by mixing the particles (Pa) made of the phosphor (Fa) and the particles (Pb) made of the phosphor (Fb) with a binder resin in respective appropriate amounts, then additionally adding an organic solvent to give a phosphor coating liquid having an appropriate viscosity, applying the liquid on an appropriate substrate by a conventional coating method such as a knife coater or a roll coater, and drying the liquid.

In this case, examples of the organic solvent that can be used to prepare the phosphor coating liquid include methyl ethyl ketone, cyclohexanone, ethanol, methyl ethyl ether, butyl acetate, ethyl acetate, ethylether, xylene, and toluene.

In addition, a dispersant such as phthalic acid or stearic acid and a plasticizer such as triphenyl phosphate or diethyl phthalate may be added to the phosphor coating liquid, as needed.

In addition, the substrate that can be used to form the scintillator layer (C1) can be the same as the support 13. Herein, in the case of using the substrate as the support 13, an appropriate layer such as the above-mentioned reflection layer may be previously formed on the substrate.

In addition, in the case of forming the radiation detector not including the support 13, the phosphor coating liquid may be directly coated on the light receiving element 11 and then dried to form the scintillator layer (C1) as long as the light receiving surface of the light receiving element 11 is durable against the phosphor coating liquid.

### Method for Manufacturing Scintillator Layer (C2)

In the case of manufacturing the radiation detector 10 including the scintillator layer (C2) as the scintillator layer 12, the scintillator layer (C2) can be formed, for example, by respectively preparing a first ink including a mixture of the particles made of the phosphor (Fa) and a UV curable resin and a second ink including a mixture of the particles made of the phosphor (Fb) and a UV curable resin, printing the first and second inks on an appropriate substrate by an inkjet technique, and curing them by UV-light irradiation.

Additionally, in the case of forming the radiation detector not including the support 13, the first and second inks may be directly printed on the light receiving element 11 by an inkjet technique and cured to form the scintillator layer (C2) as long as the light receiving surface of the light receiving element 11 is durable against the first and second inks.

### Method for Manufacturing Scintillator Layer (C3)

In the case of manufacturing the radiation detector 10 including the scintillator layer (C3) as the scintillator layer 12, the scintillator layer (C3) can be formed by a conventionally well-known method such as vapor deposition or coating. For example, in the case of forming a layer of the first and second scintillator layers 1211 and 1212 that is made of a phosphor capable of forming columnar crystals, such as CsI:Tl, CsI:Tl,Na, Y₂O₃:Tb, or BaAl₂O₄:Eu,Dy, such a layer is preferably formed by a gas phase method such as a vapor deposition method.

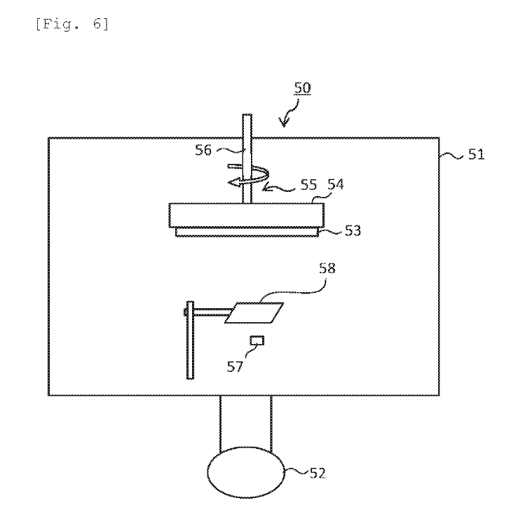

An apparatus used for the vapor deposition method is not particularly limited. For example, a vapor deposition apparatus as depicted in FIG. 6 is preferably used. The vapor deposition apparatus depicted in FIG. 6 is the same apparatus as that disclosed in WO 2010/150576.

As depicted in FIG. 6, a vapor deposition apparatus 50 includes a box-shaped vacuum chamber 51 in which a vapor deposition source 57 is disposed. The vapor deposition source 57 is placed in a state where it is accommodated in a container equipped with a heater. The vapor deposition source 57 is heated by operating the heater.

In forming the first scintillator layer 1211, a phosphor to be vapor-deposited is filled in the container equipped with the heater, and the heater is operated, whereby the phosphor can be heated and vaporized as the vapor deposition source 57. Herein, the vapor deposition source 57 may be disposed in plurality and the number thereof may be changed for each material constituting the first scintillator layer 1211. When the vapor deposition source 57 is disposed in plurality, respective vapor deposition sources 57 may be arranged at equal or different intervals.

In addition, a resistance heating crucible or the like can be used as the container equipped with the heater. Herein, a material constituting the container may be alumina or a metal having high melting point.

A holder 54 retaining the vapor deposition substrate 53 is disposed immediately above the vapor deposition source 57 in the vacuum chamber 51. Herein, in the case of forming the first scintillator layer 1211 on the support 13, the support 13 itself may be used as the vapor deposition substrate 53, or a stacked body obtained by forming a reflection layer or the like on the support 13 may be used as the substrate 53.

The holder 54 includes a heater (unillustrated), so that operation of the heater allows heating of the vapor deposition substrate 53 mounted on the holder 54. Heating of the vapor deposition substrate 53 can separate and eliminate a surface adsorbate, can prevent an impurity layer from being formed between the surface thereof and the first scintillator layer 1211 formed thereon, can enhance adhesion therebetween, and can adjust membrane quality of the first scintillator layer 1211 formed thereon.

On the holder 54 is disposed a rotation mechanism 55 that rotates the holder 54. The rotation mechanism 55 includes a rotation shaft 56 connected to the holder 54 and a motor (unillustrated) that serves as a drive source therefor. Driving the motor allows the rotation shaft 56 to be rotated, whereby the holder 54 can be rotated in a state of being opposed to the vapor deposition source 57.

In the vapor deposition apparatus 50, a vacuum pump 52 is disposed in the vacuum chamber 51, in addition to the above-mentioned structure. The vacuum pump 52 evacuates the inside of the vacuum chamber 51 and introduces a gas into the vacuum chamber 51. Operation of the vacuum pump 52 allows the inside of the vacuum chamber 51 to be maintained under a gas atmosphere with a constant pressure. The vacuum pump 52 evacuates a gas in the vacuum chamber 51. For evacuation to high vacuum range, two or more types of vacuum pumps having different operation pressure ranges may be disposed. Examples of the vacuum pump 52 that can be used include rotary pumps, turbo molecular pumps, cryopumps, diffusion pumps, and mechanical boosters.

In the case of forming the first scintillator layer 1211 by a vapor deposition method, a phosphor is filled in the container equipped with a heater, and, simultaneously with evacuation of the inside of the apparatus, an inert gas such as nitrogen is introduced from an introduction inlet to obtain a vacuum with a pressure of about from 1.333 Pa to 1.33×10⁻³ Pa. Then, the phosphor is heated and vaporized to cause vapor-deposited crystals of the phosphor to be deposited on the surface of the vapor-deposition substrate 53 optionally including a reflection layer or the like, thereby forming the first scintillator layer 1211. In the case of forming crystals made of a phosphor including an activator, a single vapor deposition source that releases a mixture of a matrix and the activator may be used as the vapor deposition source 57. Alternatively, there may be used a plurality of vapor deposition sources including a first vapor deposition source that releases the matrix and a second vapor deposition source that releases the activator.

In addition, in the case of forming the first scintillator layer 1211 including an underlayer and a phosphor layer, a phosphor for forming the underlayer, a phosphor for forming the phosphor layer, and an activator for forming the phosphor layer, respectively, are filled in different containers equipped with a heater. Vapor deposition can be performed with amounts of the respective vapor deposition sources adjusted and additionally/or while individually opening and closing the shutter 58 for each vapor deposition source.

Then, in performing vapor deposition to form the first scintillator layer 1211, specific conditions for the vapor deposition, such as a gap between the vapor deposition substrate 53 and the vapor deposition source 57 and a temperature of the holder 54, can be set as appropriate by referring to descriptions in WO 2010/150576 and JP-A-2014-232083.

In addition, the same procedures can be applied also to the formation of the second scintillator layer 1212 by a vapor deposition method, except that, as the vapor deposition substrate 53, an intermediate scintillator panel is used that is obtained by forming the first scintillator layer 1211 on a substrate constituting the support 13 or on a stacked body obtained by forming a reflection layer or the like on the substrate; as the vapor deposition source 57, a single or a plurality of vapor deposition sources are used that release a matrix and an optional activator that serve as a raw material of a phosphor constituting the second scintillator layer 1212; and a surface of the intermediate scintillator panel having the first scintillator layer 1211 thereon is a surface to be vapor-deposited. In this case, specific conditions for the vapor deposition, such as the gap between the vapor deposition substrate 53 and the vapor deposition source 57 and the temperature of the holder 54, can be similarly set as appropriate.

On the other hand, the scintillator layer (C3) can be formed also by a coating method. In this case, as for the first scintillator layer 1211 and/or the second scintillator layer 1212, particles made of a required phosphor are mixed with a binder resin in respective appropriate amounts. Additionally, an organic solvent is added to the mixture to give a phosphor coating liquid having an appropriate viscosity. The resulting phosphor coating liquid is applied on an appropriate substrate by a conventional coating method such as a knife coater or a roll coater and then dried, whereby the scintillator layer (C3) can be formed.

In this case, examples of the organic solvent that can be used to prepare the phosphor coating liquid include methyl ethyl ketone, cyclohexanone, ethanol, methyl ethyl ether, butyl acetate, ethyl acetate, ethylether, xylene, and toluene.

Additionally, a dispersant such as phthalic acid or stearic acid and a plasticizer such as triphenyl phosphate or diethyl phthalate may be added, as needed, to the phosphor coating liquid.

In addition, the substrate that can be used to form the scintillator layer (C3) can be the same as the support 13. Herein, in the case of using the substrate as the support 13, an appropriate layer such as the above-mentioned reflection layer may be previously formed on the substrate.

In the case of forming the first scintillator layer 1211 by a coating method, the first scintillator layer 1211 is obtained by coating a phosphor coating liquid including a phosphor constituting the first scintillator layer 1211 on a substrate constituting the support 13 or on a stacked body obtained by forming a reflection layer or the like on the substrate and drying the liquid. Similarly, the second scintillator layer 1212 can be obtained by coating a phosphor coating liquid including a phosphor constituting the second scintillator layer 1212 on an intermediate scintillator panel obtained by forming the first scintillator layer 1211 on the substrate constituting the support 13 or on the stacked body obtained by forming a reflection layer or the like on the substrate and drying the liquid.

In addition, the first scintillator layer 1211 and the second scintillator layer 1212 may be formed by mutually different methods. For example, the first scintillator layer 1211 may be formed by a coating method, and then, the second scintillator layer 1212 may be formed by a vapor deposition method. Alternatively, the first scintillator layer 1211 may be formed by a vapor deposition method, and then, the second scintillator layer 1212 may be formed by a coating method.

Additionally, in the case of forming the radiation detector not including the support 13, the scintillator layer (C3) may be formed by directly forming the second scintillator layer 1212 on the light receiving surface of the light receiving element 11 and then, forming the first scintillator layer 1211 on the second scintillator layer 1212 as long as the light receiving surface of the light receiving element 11 is durable against the vapor deposition conditions and the phosphor coating liquid.

### [Radiation Imaging System]

In relation to the radiation detector described above, the present invention also provides a radiation imaging system.

The radiation imaging system of the invention includes the phosphors (Fa) and (Fb) as phosphors for converting an X-ray into light and a light receiving element that uses an internal photoelectric effect as an element for converting light energy from the phosphors into electrical signals (i.e., the “light receiving element”), and has the same structure as that of conventionally well-known radiation imaging systems, except for performing, for one-shot X-ray exposure, reading of morphological image information based on fluorescence emitted from the phosphors (Fa) and (Fb), a plurality of times at a time interval. In general, a radiation imaging system includes an X-ray source, an arithmetic processing unit, and a monitor, and is also referred to as X-ray imaging apparatus. Then, the system has functions of irradiating a subject to be examined with an X-ray emitted from the X-ray source, detecting an X-ray having passed through the body of the subject to be examined by a radiation detector, analyzing and processing information obtained by the radiation detector through the arithmetic processing unit, and, as needed, displaying an obtained image on the monitor.

In a more typical embodiment, the radiation imaging system of the invention includes:

(i) an X-ray irradiation apparatus including an X-ray source that irradiates a subject with an X-ray;

(ii) the radiation detector of the invention; and

(iii) a console including an arithmetic processing unit, a monitor, an input device, and an image processing unit.

Herein, the subject is a target to be subjected to X-ray imaging, and the above-mentioned subject to be examined corresponds to the subject referred to here.

The console is electrically connected to the X-ray irradiation apparatus and the radiation detector and controls the irradiation apparatus and the radiation detector. Additionally, the console acquires information from the radiation detector, analyzes and processes the information through the arithmetic processing unit, and, as needed, displays an obtained image on the monitor.

Examples of the monitor include a CRT, a liquid crystal display, and a plasma display.

Examples of the input device include a keyboard, a mouse, a trackball, a touch pen, and a touch panel. An operator inputs an instruction of imaging and an instruction content thereof through the input device.

The arithmetic processing unit includes a CPU and a memory, and may further include a computer-readable non-transitory recording medium storing a program used to perform arithmetic processing, such as a ROM, a magnetic disc, or an optical disc. Herein, the arithmetic processing unit analyzes and processes information obtained by the radiation detector. In addition, information obtained through analysis and processing by the arithmetic processing unit may be referred to as “calculated information”.

The image processing unit includes a graphics processing unit (GPU) and a memory and forms an image from the calculated information. Specifically, the image processing unit converts, of the calculated information, information corresponding to an entire region or a partial region of a site detected by the radiation detector into corresponding image data that can be displayed on the monitor, and transmits the image data to the monitor to allow the monitor to display the image data. Herein, in a case where the CPU constituting the arithmetic processing unit is included in a microprocessor, the GPU may be provided separately from the microprocessor outside the microprocessor or may be incorporated in the microprocessor.

Additionally, the radiation imaging system may further include an image recording unit for storing an image obtained from the calculated information. The image recording unit includes a rewritable non-transitory recording medium, and examples thereof include solid state drives (SSDs), magnetic discs, and other various kinds of recordable optical discs such as CD-R and DVD-R. Additionally, the image recording unit may store the calculated information itself, together with the image.

In a specific embodiment of the invention, the radiation imaging system of the invention includes the above-described radiation detector of the invention and a mechanism that performs arithmetic processing by using information obtained by the plurality of times of the reading. Herein, the “mechanism that performs arithmetic processing” means a mechanism that performs an operation of converting the input information according to a specific rule to give one result, and is also referred to as arithmetic processing unit. In other words, the “mechanism that performs arithmetic processing” includes a CPU, a memory, and the like. In the present invention, based on morphological image information read from the above-described radiation detector of the invention a plurality of times, the “mechanism that performs arithmetic processing” performs appropriate arithmetic processing, such as a histogram analysis and/or a brightness adjustment for each pieces of the morphological image information and difference processing between the mutually different pieces of morphological image information, thereby extracting calculated information that serves as a source for a subtraction image.

In addition, in a preferable embodiment of the invention, the radiation imaging system of the invention further includes a mechanism that forms an image from the calculated information obtained by the arithmetic processing. The “mechanism that forms an image” corresponds to the above-described image processing unit, and thus includes a GPU and a memory.

### [X-Ray Image Formation Method]

In the present invention, in relation to the radiation detector and the radiation imaging system, an X-ray image formation method is also derived on the basis of the notion described in the section of “Means for Performing a Plurality of Times of Reading of Morphological Image Information at a Time Interval”

The X-ray image formation method of the invention includes:

(S1) a step of exposing a subject to an X-ray and irradiating a radiation detector (X) including a phosphor (Fa′), a phosphor (Fb′) having a longer fluorescence lifetime than the phosphor (Fa′), and a light receiving element that uses an internal photoelectric effect with an X-ray having passed through the subject;

(S2) a step of acquiring first morphological image information from the radiation detector (X);

(S3) a step of acquiring second morphological image information from the radiation detector (X) after the step (S1); and

(S4) a step of forming a subtraction image on the basis of the first morphological image information obtained in the step (S2) and the second morphological image information obtained in the step (S3),

wherein the steps (S2) and (S3) are performed for one-shot X-ray exposure; and

the step (S3) is performed after termination of the X-ray irradiation of the step (S1).

Herein, in a specific embodiment of the invention, the step (S2) includes:

(S2-1) a step of starting accumulation of the first morphological image information in the radiation detector (X);

(S2-2) a step of completing the accumulation of the first morphological image information in the radiation detector (X); and

(S2-3) a step of reading the accumulated first morphological image information, and the step (S3) includes:

(S3-1) a step of starting accumulation of the second morphological image information in the radiation detector (X);

(S3-2) a step of completing the accumulation of the second morphological image information in the radiation detector (X); and

(S3-3) a step of reading the accumulated second morphological image information.

Herein, the step (S2-1) is preferably performed during the X-ray irradiation of the step (S1), and the step (S3-1) is preferably performed after the step (S2-3) is terminated after the X-ray irradiation of the step (S1). In this case, the step (S3-1) is more preferably performed after passage of a time equal to or more than a time taken for an amount of luminescence from the phosphor (Fa) to reach 3/100 of an amount of luminescence thereof at a time of cessation of the X-ray irradiation of the step (S1) from the time of the cessation of the X-ray irradiation thereof.

The phosphors (Fa′) and (Fb′) constituting the radiation detector (X) are the same as the “phosphor (Fa)” and the “phosphor (Fb)”, respectively, and examples of the “light receiving element that uses an internal photoelectric effect” include those described in the section of “Light Receiving Element Using Internal Photoelectric Effect” in the “Radiation Detector”. Then, in the radiation detector (X), the phosphors (Fa′) and (Fb′) are preferably disposed parallel to each other or stacked vertically on top of each other, with respect to a radiation incidence direction, and particularly preferably, stacked vertically on top of each other with respect to a radiation incidence direction, as with the “phosphor (Fa)” and the “phosphor (Fb)” used in “the radiation detector” according to the present invention. In the radiation detector (X), the phosphors (Fa′) and (Fb′) constitute a scintillator layer and are located on a surface of the “light receiving element”.

Herein, the radiation detector (X) itself used to perform the X-ray image formation method does not necessarily have the “means for performing, for one-shot X-ray exposure, a plurality of times of reading of morphological image information at a time interval”. In other words, the radiation detector (X) may have a structure excluding the “means for performing, for one-shot X-ray exposure, a plurality of times of reading of morphological image information at a time interval”. Accordingly, the X-ray image formation method can also be performed by a radiation imaging system that includes the radiation detector (X) not including the “means for performing, for one-shot X-ray exposure, a plurality of times of reading of morphological image information at a time interval” and the “means for performing, for one-shot X-ray exposure, a plurality of times of reading of morphological image information at a time interval”. For example, an apparatus constituting the “mechanism that performs arithmetic processing” may serve as the “means for performing, for one-shot X-ray exposure, a plurality of times of reading of morphological image information based on fluorescence emitted from the phosphors (Fa) and (Fb) at a time interval”.

In addition, in one of preferable embodiments of the invention, the X-ray image formation method is performed using the radiation detector according to the invention, and in this case, the radiation detector according to the invention is used as the radiation detector (X).

### EXAMPLES

Hereinafter, the present invention will be described in detail with reference to Examples. However, the invention is not limited thereto.

### EMBODIMENT

The radiation detection apparatus includes a light receiving element (a sensor panel) that uses an internal photoelectric effect, a first scintillator layer, and a second scintillator layer. The second scintillator layer is disposed on the sensor panel, and the first scintillator layer is disposed on the second scintillator layer.

### [Measurements of Fluorescence Lifetimes and Mass Attenuation Coefficients]

For the following Examples and Comparative Examples, a fluorescence lifetime τ1 of a phosphor used in the first scintillator layer and a fluorescence lifetime τ2 of a phosphor used in the second scintillator layer were obtained by exposing each of the phosphors constituting the scintillator layers to an X-ray with a tube voltage of 80 keV and measuring temporal changes in an amount of luminescence from each phosphor by using an apparatus constituted by connecting an optical fiber (PLG-1-3000-8R, manufactured by Nippon P•I Co. Ltd.), a photodiode (S2281-01, manufactured by Hamamatsu Photonics K.K.), and a photosensor amplifier (C9329 manufactured by Hamamatsu Photonics K. K.). Specifically, for the respective Examples and Comparative Examples, as fluorescence lifetime measurement samples, there were prepared a scintillator panel having the first scintillator layer but not the second scintillator layer and a scintillator panel having the second scintillator layer but not the first scintillator layer, respectively. Each of the fluorescence lifetime measurement samples was subjected to the above-described X-ray exposure and measurements. Then, for each of the fluorescence lifetime measurement samples, a time taken for an amount of luminescence to reach 1/100 of an amount of luminescence at a time of cessation of the X-ray irradiation from the time of the cessation of the X-ray irradiation was obtained as a fluorescence lifetime. The obtained fluorescence lifetimes for the samples were defined as τ1 and τ2, respectively.

Additionally, a mass attenuation coefficient μ1 of the phosphor used in the first scintillator layer and a mass attenuation coefficient μ2 of the phosphor used in the second scintillator layer were obtained by referring to values available from the website of the National Institute of Standards and Technology (NIST).

Results are shown in Table 1A.

### Example 1

As for the first and second scintillator layers, first, the first scintillator layer was formed by coating on a support, and then, the second scintillator layer was formed by vapor deposition on the first scintillator layer.

The first scintillator layer was formed as follows.

As the phosphor having a longer fluorescence lifetime, i.e., as the phosphor (Fb), ZnS:Cu,Cl (GAF-5GN, manufactured by Nemoto Lumi-Materials Co., Ltd., 5 μm in average particle size) and, as a binder resin, a polyester resin (VYLON 550, manufactured by Toyobo Co., Ltd.) were added together and mixed with cyclohexanone and methyl ethyl ketone (MFK) as solvents, followed by dispersion processing in a sand mill to give a first scintillator layer coating. The light scattering particles and the binder resin were contained in a solid content ratio (vol %) of 85:15. The coating was coated on a polyimide film support (UPILEX S, manufactured by Ube Industries, Ltd., 125 μm in thickness) having a width of 500 mm by a comma coater, and then dried at 60° C. for 20 minutes to give a first scintillator layer including the support and the phosphor (a first scintillator coating sample: 100 μm in layer thickness).

Next, the second scintillator layer was formed using the vapor deposition apparatus 50 depicted in FIG. 6 as follows. The vapor deposition apparatus depicted in FIG. 6 is the same as that disclosed in WO 2010/150576 and JP-A-2014-232083.

First, as the phosphor having a shorter fluorescence lifetime, i.e., as the phosphor (Fa), a phosphor compound (CsI: activator TlI) was filled in a resistance heating crucible and used as a vapor deposition source 57. Additionally, the first scintillator coating sample was placed as a vapor deposition substrate 53 on a rotatable holder 54. In this case, the first scintillator coating sample was placed so that a support surface of the sample was contacted with the holder 54. Additionally, the gap between the first scintillator coating sample and the vapor deposition source 57 was adjusted to 400 mm.

Subsequently, air inside the vacuum chamber 51 of the vapor deposition apparatus 50 was once evacuated, and Ar gas was introduced to adjust the degree of vacuum inside the vacuum chamber 51 of the vapor deposition apparatus 50 to 0.5 Pa (absolute pressure). After that, the holder 54 was heated while rotating the holder 54 with the first scintillator coating sample thereon at 10 rpm, and the temperature of the first scintillator coating sample was maintained at 200° C.

Next, the resistance heating crucible (the vapor deposition source 57) was heated to cause the phosphor to be vapor-deposited on a surface of the first scintillator coating sample having the first scintillator layer thereon to form a second scintillator layer, and the vapor deposition was terminated at a time when the film thickness of the second scintillator layer reached 400 μm, thereby giving a scintillator panel having the second scintillator layer (CsI: 0.003Tl; Tl 0.3 mol %) having the predetermined film thickness formed thereon. The obtained scintillator panel was set in XINEOS (CMOS) that is a photoelectric conversion element panel capable of optionally setting electrical charge accumulation and reading timing (Hereinafter “CMOS flat panel”) to give a radiation detector. The photoelectric conversion element panel serves as the “light receiving element that uses an internal photoelectric effect”.

In the obtained radiation detector, an X-ray emitted from an X-ray irradiation apparatus set at a tube pressure of 120 Kvp was applied to a subject, and an X-ray having passed through the subject was applied to the radiation detector. The X-ray applied to the radiation detector was first applied to the first scintillator layer, whereby the first scintillator layer emitted visible light having an intensity in accordance with the intensity of the irradiated X-ray for a certain length of time according to the fluorescence lifetime of the included phosphor.

Part of the irradiated X-ray that was not converted by the first scintillator layer transmitted through the first scintillator layer, reached the second scintillator layer, and was converted into visible light, thereby emitting light for a certain length of time according to the fluorescence lifetime of the included phosphor.

During X-ray exposure, the visible light emitted from the first and second scintillator layers was received and photoelectrically converted by the light receiving element, whereby a signal electrical charge was accumulated in the photo diode according to luminance intensity. After that, the signal electrical charge was read from a transmission unit, whereby an image signal HI was output as an electrical signal.

Even after the X-ray exposure was ceased and the luminescence from the first scintillator layer disappeared, the luminescence from the second scintillator layer continued. The luminescence allowed a signal electrical charge to be accumulated in the photodiode of the light receiving element, and the signal electrical charge was read again, whereby an image signal LI was output as an electrical signal.

The output electrical signals HI and LI were arithmetically processed, as a result of which an intended subtraction image was able to be obtained.

### Example 2

A scintillator panel having first and second scintillator layers formed thereon and a radiation detector were produced in the same manner as in the Example 1, except that Y₂O₃:Tb that is a phosphor having a shorter fluorescence lifetime than Example 1 was used in place of the phosphor used to form the first scintillator layer in Example 1.

### Example 3

A scintillator panel having a first scintillator layer and a second scintillator layer (CsI: 0.003Tl, 0.015Na; Tl 0.3 mol %, Na 1.5 mol %) having a longer fluorescence lifetime than the second scintillator layer of Example 1 formed thereon and a radiation detector were produced in the same manner as Example 1, except that the vapor deposition source used to form the second scintillator layer in Example 1 was replaced with a resistance heating crucible containing a phosphor compound (CsI: activator TlI) and a resistance heating crucible containing a coactivator (NaI), respectively.

### Example 4

A scintillator panel having first and second scintillator layers formed thereon and a radiation detector were produced in the same manner as Example 1, except that BaAl₂O₄:Eu,Dy that is a phosphor having a larger mass attenuation coefficient in X-ray irradiation at 80 keV than Example 1 was used in place of the phosphor used to form the first scintillator layer in Example 1.

### Example 5

As for formation of first and second scintillator layers, a first scintillator layer was formed by vapor deposition on a polyimide film support (UPILEX S, manufactured by Ube Industries, Ltd., 125 μm in thickness), and then, a second scintillator layer was formed by coating on the first scintillator layer.

In the same way as in the vapor deposition method of Example 1, a resistance heating crucible containing a phosphor compound (CsI: activator TlI) and a resistance heating crucible containing a coactivator (NaI) were used as a vapor deposition source in forming the first scintillator layer, thereby forming a first scintillator layer (CsI: 0.003Tl, 0.015Na; Tl 0.3 mol %, Na 1.5 mol %) having a longer fluorescence lifetime than the second scintillator layer of Example 1 on the support.

Next, in the same way as in the coating method of Example 1, on the vapor-deposited first scintillator layer was formed a second scintillator layer by coating using Gd₂O₂S:Tb as a phosphor to give a scintillator panel having the first and second scintillator layers formed thereon and a radiation detector.

### Example 6

As for formation of first and second scintillator layers, a first scintillator layer was formed by vapor deposition on a polyimide film support (UPILEX S, manufactured by Ube Industries, Ltd., 125 μm in thickness), and then, a second scintillator layer was formed by vapor deposition on the first scintillator layer.

In the same way as in the vapor deposition method of Example 1, a resistance heating crucible containing a phosphor compound (CsI: activator TlI) and a resistance heating crucible containing a coactivator (NaI) were used as a vapor deposition source in forming the first scintillator layer, thereby giving a first scintillator layer (CsI: 0.003Tl, 0.015Na; Tl 0.3 mol %, Na 1.5 mol %) having a longer fluorescence lifetime than the second scintillator layer of Example 1 on the support.

Next, using the same method as in the formation of the second scintillator layer of Example 1, a second scintillator layer (CsI: 0.003Tl; Tl 0.3 mol %) was formed by vapor deposition on the vapor-deposited first scintillator layer to give a scintillator panel having the first and second scintillator layers formed thereon and a radiation detector.

### Comparative Example 1

A scintillator panel having first and second scintillator layers formed thereon and a radiation detector were produced in the same manner as Example 5, except that (CsI: activator TlI) was used as a phosphor used to form the first scintillator layer.

### Comparative Example 2

A scintillator panel and a radiation detector were produced by using the same phosphor (CsI: activator TlI) for first and second scintillator layers in Example 6.

### Evaluation Method

The respective radiation detectors obtained in the Examples and the Comparative Examples were evaluated as follows.

Using an X-ray irradiation apparatus set at a tube pressure of 120 Kvp, an X-ray was applied to the radiation detectors through a step made of aluminum (hereinafter “aluminum step”).

Herein, as the “aluminum step”, a stepwise step made of aluminum was used that had eight steps (0.3 mm in minimum thickness and 2.4 mm in maximum thickness) provided with a level difference of 0.3 mm for each in a stepped manner. X-ray was applied from a back surface (a surface without any scintillator layer) of the scintillator panel constituting each of the radiation detectors.

Morphological image information based on radiation detected by the each radiation detector was accumulated in form of signal charges in the CMOS flat panel constituting the radiation detector. Herein, reading of the signal charges accumulated in the CMOS flat panel were performed twice, during exposure and after 33 msec from exposure cessation, respectively, and then the read signal charges were recorded in form of image data in hard disk. Signal charges read for a second time were those accumulated after cessation of the radiation exposure.

Obtained two X-ray images were evaluated in terms of subject contrast and the amount of noise in the X-ray image obtained by second reading.

Herein, in image data obtained as X-ray images of the aluminum step, the aluminum step images are observed as those consisting eight regions having mutually different degrees of luminance in a manner corresponding to the positions and thicknesses of the eight steps. Accordingly, when a histogram is obtained for the image data, there appear eight peaks corresponding to the degrees of brightness at the eight steps and a peak corresponding to a background region other than the aluminum step.

Based on that, as for the contrast, inter-peak widths were measured from the histogram for each of the two X-ray images obtained through the aluminum step, and there was calculated a difference ΔL between the degree of brightness at a peak point having highest brightness and the degree of brightness at a peak point having lowest brightness among the peaks, and the difference ΔL was defined as a contrast. Then, evaluation was made using a contrast difference: (ΔL1−ΔL2), where ΔL1 was ΔL of an X-ray image obtained by first reading and ΔL2 was ΔL of an X-ray image obtained by second reading.

On the other hand, as for the amount of noise in the X-ray image, a magnitude of noise with respect to an amount of luminescence was evaluated from a profile analysis of the X-ray images obtained by the second reading, and the magnitude of noise with respect to the amount of luminescence was defined as “amount of noise”.

The obtained subtraction image had higher image quality as the contrast difference between the respective X-ray images obtained by the first and second readings was larger and the X-ray image obtained at the second reading had a smaller amount of noise.

In addition, chest phantom imaging was performed similarly by twice reading to confirm a subtraction image.

Based on Example 5 exhibiting characteristics of energy subtraction applicable level, a level equivalent to each of the amount of noise and the contrast difference of Example 5 was indicated by “◯”, and a level better than that of Example 5 was indicated by “⊙”. On the other hand, a level worse than the amount of noise of Example 5 was indicated by “Δ”, and a level still worse than the level indicated by the “Δ” was indicated by “X”. Namely, the amount of noise increases in the following order: “⊙”<“◯”<“Δ”<“X”. In addition, the quality level of the subtraction image (“subtraction image quality” in Table 1B) obtained in Example 5 was evaluated as level 1 of a four-level grading system (0 to 3). Herein, the level 0 in quality level of the subtraction image means that no subtraction image was obtained or the subtraction image was unclear.

Results are shown in Table 1B.

TABLE 1A

| | First scintillator layer | | | | Second scintillator layer | | | | | |
|---|---|---|---|---|---|---|---|---|---|---|
| | Phosphor | τ1 | | Type of | Phosphor | τ2 | | Type of | | |
| | compound | msec | μl | phosphor | compound | msec | μ2 | phosphor | τ1/τ2 | μ2/μ1 |
| Ex. 1 | ZnS:Cu, Cl | 1000 | 0.6463 | Fb | CsI:Tl | 2 | 3.677 | Fa | 500 | 5.7 |
| Ex. 2 | Y₂O₃:Tb | 40 | 1.301 | Fb | CsI:Tl | 2 | 3.677 | Fa | 20 | 2.8 |
| Ex. 3 | ZnS:Cu, Cl | 1000 | 0.6463 | Fb | CsI:Tl, Na | 50 | 3.677 | Fa | 20 | 5.7 |
| Ex. 4 | BaAl₂O₄:Eu, Dy | 800 | 2.217 | Fb | CsI:Tl | 2 | 3.677 | Fa | 400 | 1.7 |
| Ex. 5 | CsI:Tl, Na | 50 | 3.677 | Fb | GOS:Tb | 2.5 | 4.666 | Fa | 20 | 1.3 |
| Ex. 6 | CsI:Tl, Na | 50 | 3.677 | Fb | CsI:Tl | 2 | 3.677 | Fa | 25 | 1 |
| Comp. | CsI:Tl | 2 | 3.677 | Fb | GOS:Tb | 2.5 | 4.666 | Fa | 0.8 | 1.3 |
| Ex. 1 | | | | | | | | | | |
| Comp. | CsI:Tl | 2 | 3.677 | Fb | CsI:Tl | 2 | 3.677 | Fa | 1 | 1 |
| Ex. 2 | | | | | | | | | | |

TABLE 1B

| | | | Subtraction image |
|---|---|---|---|
| | Amount of Noise | Contrast difference | quality |
| Ex. 1 | ⊙ | ⊙ | 3 |
| Ex. 2 | ◯ | ⊙ | 2 |
| Ex. 3 | ◯ | ⊙ | 2 |
| Ex. 4 | ⊙ | ◯ | 2 |
| Ex. 5 | ◯ | ◯ | 1 |
| Ex. 6 | ◯ | ◯ | 1 |
| Comp. | Δ | ◯ | 0 |
| Ex. 1 | | | |
| Comp. | X | ◯ | 0 |
| Ex. 2 | | | |

The results presented in Table 1B clearly indicate that subtraction images have been obtained in the Examples according to the present invention.

While some embodiments have been described hereinabove, the present invention is not limited thereto. It is obvious that the purpose, state, application, function, and other specifications can be changed as appropriate and the invention can also be implemented by other embodiments.

### REFERENCE SIGNS LIST

10: Radiation detector of the present invention
11: Light receiving element
12: Scintillator layer
1211: First scintillator layer
1212: Second scintillator layer
1221: Dot (Da) including Phosphor (Fa)
1222: Dot (Db) including Phosphor (Fb)
13: Support
50: Vapor deposition apparatus
51: Vacuum chamber
52: Vacuum pump
53: Vapor deposition substrate
54: Holder
55: Rotation mechanism
56: Rotation shaft
57: Vapor deposition source
58: Shutter

What is claimed is:

1. A radiation detector comprising:
a phosphor (Fa);
a phosphor (Fb) having a longer fluorescence lifetime than the phosphor (Fa);
a light receiving element that uses an internal photoelectric effect; and
a controller that controls the light receiving element to perform, for one-shot X-ray irradiation, reading of morphological image information based on fluorescence emitted from the phosphors (Fa) and (Fb), a plurality of times at a time interval.

2. The radiation detector according to claim 1, wherein the phosphors (Fa) and (Fb) satisfy the following requirement X:
requirement X: the phosphors (Fa) and (Fb) satisfy a relationship: τb/τa is 16.5 or more, where τa and τb respectively represent periods of time taken for amounts of luminescence from the phosphors (Fa) and (Fb) to reach 1/100 of amounts of luminescence therefrom at a time of cessation of X-ray irradiation from the time of the cessation of the X-ray irradiation.

3. The radiation detector according to claim 2, wherein the τb/τa is 65 or more.

4. The radiation detector according to claim 1, wherein the phosphors (Fa) and (Fb) satisfy a relationship: μa/μb or μb/μa is 1.2 or more, where μa and μb respectively represent mass attenuation coefficients of the phosphors (Fa) and (Fb) at a time of X-ray irradiation at a tube voltage of 80 keV.

5. The radiation detector according to claim 4, wherein the μa/μb or μb/μa is 2.8 or more.

6. The radiation detector according to claim 1, wherein a matrix constituting the phosphor (Fa) is the same as a matrix constituting the phosphor (Fb).

7. The radiation detector according to claim 1, wherein the phosphors (Fa) and (Fb) are disposed parallel to each other or stacked vertically on top of each other, with respect to an X-ray incidence direction.

8. The radiation detector according to claim 1, wherein the phosphors (Fa) and (Fb) are stacked vertically on top of each other with respect to an X-ray incidence direction.

9. The radiation detector according to claim 8, wherein when μa≦μb, the phosphor (Fa) is located closer to a radiation incidence side, whereas when μa>μb, the phosphor (Fb) is located closer to the radiation incidence side, where μa and μb respectively represent mass attenuation coefficients of the phosphors (Fa) and (Fb) at a time of X-ray irradiation at a tube voltage of 80 keV.

10. The radiation detector according to claim 1, wherein accumulation of first morphological image information in the light receiving element is started during X-ray irradiation, and accumulation of second morphological image information in the light receiving element is started after the accumulation of the first morphological image information and reading thereof are terminated after termination of the X-ray irradiation.

11. The radiation detector according to claim 10, wherein the accumulation of the second morphological image information is performed after passage of a time equal to or more than a time taken for an amount of luminescence from the phosphor (Fa) to reach 3/100 of an amount of luminescence therefrom at a time of cessation of the X-ray irradiation from the time of the cessation of the X-ray irradiation.

12. A radiation imaging system comprising the radiation detector according to claim 1 and a mechanism that performs arithmetic processing by using morphological image information obtained by the plurality of times of the reading.

13. The radiation imaging system according to claim 12, comprising a mechanism that forms an image from calculated information obtained from the arithmetic processing.
